(19) United States
(12) Patent Application Publication
(10) Pub. No.: US 2009/0169430 A1
(43) Pub. Date: Jul. 2, 2009

(54) PANEL FOR ANALYZING SAMPLE LIQUID

(75) Inventors: Tomohiro Yamamoto, Osaka (JP); Toshihiko Yoshioka, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 12/295,405

(22) PCT Filed: Apr. 4, 2007
(86) PCT No.: PCT/JP2007/057566

§ 371 Date: Sep. 30, 2008

(30) Foreign Application Priority Data
Apr. 4, 2006 (JP) 2006-102707

(51) Int. Cl. B04B 5/00; B01J 19/00

(52) U.S. Cl. 422/72; 422/68.1

(57) ABSTRACT

A panel for analyzing a sample liquid by which an exactly fixed quantity of sample liquid can be dripped conveniently, and convenience of measuring operation and accuracy of measurements can be ensured even for a sample liquid containing solid components. The panel for analyzing a sample liquid comprises a first channel-like chamber which is rotated about the center of rotation and into which the sample liquid flows by capillarity, a first channel connected to the first chamber and having a cavity the width or the height of which is increased discontinuously, a second chamber connected to the first channel, an opening for supplying the sample liquid to the first chamber, and an opening for discharging gas from the first chamber as the sample liquid flows in.

### TECHNICAL FIELD

The present invention relates to a sample solution analyzing panel. More particularly, the present invention relates to a sample solution analyzing panel for analyzing a sample by reacting a liquid sample with a reagent and detecting the chemical reaction.

### BACKGROUND ART

In recent years, advancement in analysis and testing technologies has made it possible to measure various matters. Particularly, in the field of clinical testing, measurement systems based on specific reactions such as biochemical reaction, enzyme reaction and immune reaction are developed, which has made it possible to measure matters in body fluids, which reflect clinical conditions.

Out of these measurement systems, attention is focused upon an area in clinical laboratory called “point of care testing (POCT).” POCT is characterized by simple and quick measurement, and efforts are made to shorten the time from when a sample is collected until a measurement result is obtained. Therefore, POCT requires a simple measurement system and a compact and portable measuring apparatus that is easy to operate.

Presently, measuring devices of practical use supporting POCT have started being provided as a result of establishment of a simple measurement system and progress in an immobilizing technique for biogenic matters, sensor device technique, sensor system technique and micro fluid control technique. As an analyzing apparatus that can be used as a measuring device supporting POCT, an apparatus, which is a panel member and which performs qualitative and quantitative analysis of a liquid sample supplied in the apparatus, is proposed (for example, see Patent Document 1). A measuring device using the technique disclosed in Patent Document 1 can be used to diagnose disease by analyzing liquid samples such as blood.

Further, as the analyzing apparatus, a panel member is proposed which is provided with a plurality of chambers and flow paths connecting the plurality of chambers and which has an additional function of freely moving and holding a sample solution (for example, see Patent Document 2). By this means, for example, by removing the blood cells in blood by centrifugal separation to react only the plasma components in blood, which is a sample solution, with reagents, or by making a plurality of chambers hold solid reagents, it is possible to sequentially dissolve and react the sample solution with a plurality of solid reagents.

To make the chambers hold solid reagents in advance, a reagent solution may be dropped in the chambers and dried. The concentration and quantity of the reagent solution dropped in the chambers may be adjusted to enable analysis of the reagent solution when solid reagents are dissolved in the reagent solution supplied in the chambers.

As the analyzing apparatus, a panel member that has an additional function of introducing a certain amount of sample solution, is proposed (for example, see Patent Document 3). The panel member disclosed in Patent Document 3 has a suction cavity for sucking in a certain amount of sample solution by capillary action, an analyzing cavity having a reagent and a flow path that connects the suction cavity and the analyzing cavity. This flow path has a narrowed part provided with a space where the area of the flow path is narrowed. The narrowed part has a function of holding a sample in the suction cavity when the sample is sucked in the suction cavity, and has a function of moving the sample held in the suction cavity to the analyzing cavity through the space, when centrifugal force is applied from outside in a state where the sample is held in the suction cavity.

By these two functions of the narrowed part, a certain amount of sample solution can be collected in a simple manner, and the collected sample solution can be moved to an analyzing area by centrifugal force. In this way, a certain amount of sample can be introduced to an analyzing panel without using special measurement equipment.

### Patent Document 1: International Publication No. 00/26677 Pamphlet

### Patent Document 2: Japanese Patent Application Publication No. 2002-534096

### Patent Document 3: Japanese Patent Application Laid-Open No. 2006-308561

### DISCLOSURE OF INVENTION

### Problems to be Solved by the Invention

To dispense drops of sample solution such as blood in the conventional sample solution analyzing panel shown in FIG. 1, the drops of sample solution need to be dispensed in sample solution supply port 20a using, for example, a pipette prepared separately. Although drops of blood bleeding from, for example, the fingertip can be dispensed directly from the fingertip, it is difficult to dispense a certain amount of drops of blood in a disk accurately. Further, when drops of blood are dispensed directly from the fingertip, blood may adhere near the periphery of sample solution supply port 20a and may stain the analyzing apparatus upon measurement.

According to the panel member disclosed in Patent Document 3, the narrowed part of the flow path that connects the suction cavity and the analyzing cavity, holds the sample solution in the suction cavity in a stationary state, so that a certain amount of drops of sample solution corresponding to the capacity of the suction cavity can be dispensed. Further, by making centrifugal force at work after drops of sample solution are dispensed, the sample solution in the suction cavity flows so actively that the sample solution overcomes the holding capacity of the narrowed part and is sent in the analyzing cavity. However, if drops of a sample (for example, blood) containing solid components of higher specific gravity than the liquid components are dispensed on the panel member disclosed in Patent Document 3 and centrifugal force is made at work, cases may occur where the solid components are accumulated in the part connecting the suction cavity and the analyzing cavity, block the flow path (particularly, narrowed part) and thereby make the solution transfer difficult.

It is therefore an object of the present invention to provide a sample solution analyzing panel that can dispense a certain amount of drops of sample solution accurately in a simple manner, secure simple measurement operation and correct measurement values even when the sample solution contains solid components.

### Means for Solving the Problem

The present invention relates to the sample solution analyzing panel described below. The sample solution analyzing panel that is rotated around a center of rotation, includes: a first chamber in a shape of a flow path, into which a sample solution flows by capillary action; a first flow path which is connected to the first chamber and has cavities in which a dimension of width or height is made large in a discontinuous manner with respect to the first chamber; a second chamber which is connected to the first flow path; a supply opening part through which the sample solution is supplied in the first chamber; and an exhaust opening part through which a gas is exhausted by inflow of the sample solution. And in the sample solution analyzing panel, the first flow path is arranged between the supply opening part and the exhaust opening part; the supply opening part is open toward the center of rotation set inside the panel or outside the panel; a distance between the center of rotation and the supply opening part is equal to a distance between the center of rotation and a part in the exhaust opening part farthest from the center of rotation; a part connecting the first chamber and the first flow path is arranged farther from the center of rotation than the supply opening part and the exhaust opening part; and at least a part in an inner wall surface of the first chamber is subjected to treating of increasing wettability with respect to the sample solution.

The sample solution analyzing panel of the present invention is particularly suitable for analyzing a sample solution containing a liquid component and a solid component of higher specific gravity than the liquid component.

### ADVANTAGEOUS EFFECT OF THE INVENTION

The present invention can provide a sample solution analyzing panel that can dispense a certain amount of drops of sample solution accurately in a simple manner, secure simple measurement operation and correct measurement values even when the sample solution contains solid components. Therefore, the present invention is applicable to, particularly, apparatuses for analyzing blood as a sample solution, more preferably, applicable to measurement devices supporting POCT.

### BRIEF DESCRIPTION OF DRAWINGS

FIG. 1 is a plan view of a conventional sample analyzing disk;

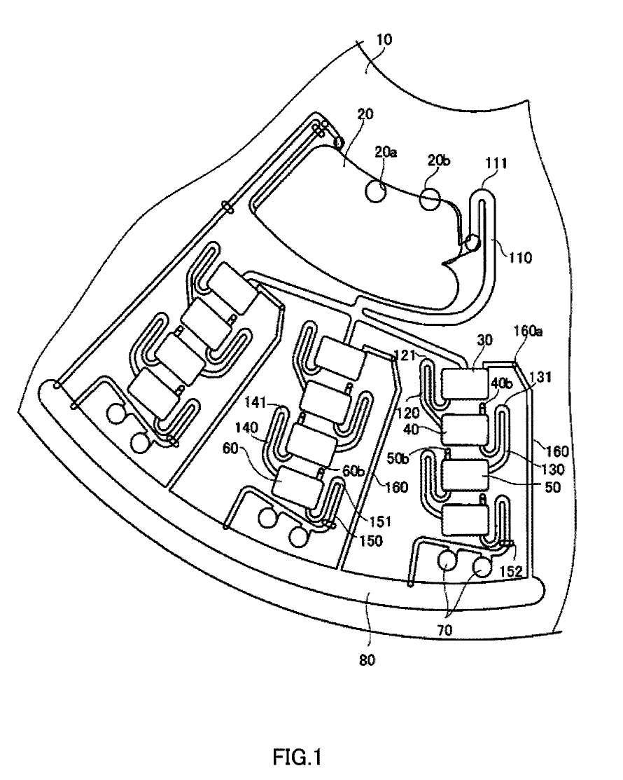

FIG. 2 is a perspective view of an analyzing apparatus to which a sample solution analyzing panel is attached;

FIG. 3 is a plan view of the sample solution analyzing panel of FIG. 2;

FIG. 4 is a perspective view of an analyzing apparatus to which a sample solution analyzing panel of another example is attached;

FIG. 5 is a plan view of a first example of the sample solution analyzing panel of FIG. 4;

FIG. 6 is a plan view of the second example of the sample solution analyzing panel of FIG. 4; and

FIG. 7 is a plan view of the third example of the sample solution analyzing panel of FIG. 4.

### BEST MODE FOR CARRYING OUT THE INVENTION

The sample solution analyzing panel of the present invention has a configuration including: (1) a first chamber in a shape of a flow path, into which a sample solution flows by capillary action; (2) a first flow path which is connected to the first chamber and has cavities in which the dimension of width or height is made large in a discontinuous manner with respect to the first chamber; and (3) a second chamber connected with the first flow path. Further, in the first chamber, a supply opening part through which a sample solution is supplied and an exhaust opening through which the gas in the first chamber is exhausted when the sample solution flows in the first chamber, are formed. Further, the part connecting the first chamber and the first flow path is arranged between the supply opening part and the exhaust opening part.

Upon analysis, a sample solution is supplied into the first chamber through the supply opening part, and the amount of the sample solution supplied is specified by the capacity of the first chamber. Drops of the sample solution dispensed on the supply opening part flow into the first chamber by capillary action. If the sample solution flows into the first chamber, the gas (such as air) in the first chamber is exhausted smoothly through the exhaust opening part to outside the panel. By this means, the first chamber is finally filled with the sample solution.

The sample solution flowing into the first chamber is held in the cavity parts of the first flow path and cannot intrude into the second chamber. That is, in the cavity parts, the dimension of width or height is made large in a discontinuous manner with respect to the first chamber and the second chamber, and, therefore, by the capillary valve effect, intrusion of the sample solution by capillary action is prevented.

The sample solution analyzing panel of the present invention is rotated around the center of rotation. The center of rotation may be provided either inside the panel or outside the panel. The supply opening part for supplying the sample, provided in the first chamber is preferably open toward the center of rotation, so that the sample solution filling the first chamber is prevented from leaking outside the panel through the supply opening part when the sample solution analyzing panel is rotated.

Further, “the distance between the center of rotation and the supply opening part” and “the distance between the center of rotation and the part farthest from the center of rotation of the exhaust opening part” in the positional relationships in the plane of rotation, are preferably equal, so that, when the sample solution analyzing panel is rotated, the sample solution filling the first chamber is prevented from leaking outside the panel through either the supply opening part or the exhaust opening part.

Further, the part connecting the first chamber and the first flow path (having cavity parts) is arranged farther from the center of rotation than the supply opening part and the exhaust opening part, so that, when the sample solution analyzing panel is rotated, the capillary valve effect in the cavity parts of the first flow path is cancelled by the centrifugal force. And then the sample solution is sent to the cavity parts, the flow paths following the cavity parts and the second chamber.

In the cavity parts which work as capillary valves, the dimension of width or height is made large in a discontinuous manner with respect to the first chamber and the second chamber, so that, even if the sample solution contains solid components of higher specific gravity than the liquid components, the flow path is less likely to be blocked in the cavity parts. That is, when the sample solution flowing in the first chamber receives the centrifugal force by the rotation of the sample solution analyzing panel, the solid components of higher specific gravity in the sample solution may be accumulated in the part connecting the first flow path arranged far from the center of rotation. As described above, the capillary valves are cavity parts in which the dimension of width or height is made large in a discontinuous manner with respect to the first chamber and the second chamber, so that the flow path is less likely to be blocked in the cavity parts. On the other hand, if the capillary valves are narrowed parts where the flow path is narrowed, the solid components in the sample solution are more likely to block the flow path. Therefore, the cavity parts in which the dimension of width or height is made large in a discontinuous manner with respect to the first chamber and the second chamber, are preferably arranged as capillary valves in the first flow path of the sample solution analyzing panel of the present invention.

Part of the peripheral part of the supply opening part of the first chamber preferably protrudes in a convex shape, because, when drops of the sample solution are dispensed in the supply opening part, the sample solution can be prevented from remaining in the peripheral part of the supply opening part or spreading on the panel surface from the peripheral part of the supply opening part, and the sample solution can be made to flow in the first chamber in a reliable manner.

At least part of the inner wall surface of the first chamber is preferably subjected to treating for increasing the wettability with respect to the sample solution, so that the sample solution is made to flow easily into the first chamber by capillary action. For example, when the sample solution primarily consists of water, the inner wall surface may be subjected to hydrophilicity treatment, and the contact angle of water of the surface subjected to the hydrophilicity treatment may be less than 90 degrees.

The side wall farther from the center of rotation in the first chamber has such a shape that the side wall moves away from the center of rotation from the supply opening part to the part connecting the first chamber and the first flow path without turning to the center of rotation. In the same way, the side wall of the first chamber farther from the center of rotation has such a shape that the side wall moves away from the center of rotation from the exhaust opening part to the part connecting the first chamber and the first flow path without turning to the center of rotation. By this means, when the sample solution analyzing panel is rotated, all the sample solution filling the first chamber can be sent to the second chamber through the first flow path, and the sample solution can be prevented from remaining in the first chamber.

The second chamber accommodates the sample solution sent from the first chamber. When the sample solution contains liquid components and solid components of higher specific gravity than the liquid components, it is preferable to separate the solid components in the second chamber and extract the liquid components. For example, when the sample solution is blood, the blood cell components are removed in the second chamber, and only the plasma components are extracted to be used for analysis.

To separate the solid components of the higher specific gravity from the sample solution to extract the liquid components in the sample solution, the centrifugal force by the rotation of the sample solution analyzing panel and the capillary force that makes the liquid components of the sample solution intrude into the second flow path connected to the second chamber, are preferably used in combination. Therefore, the second flow path connected to the second chamber is preferably connected to a part closer to some extent to the center of rotation instead of being connected to the part farthest from the center of rotation in the second chamber. By accumulating the solid components in a part of the second chamber farther from the center of rotation than the part connecting with the second flow path, the solid components are prevented from entering the second flow path. For example, when the sample solution is blood, the second flow path is preferably connected to the position where approximately sixty percent of the fluid capacity of the first chamber can be sucked in with the capillary force by the second flow path. Further, the configuration of the second chamber may be designed with reference to Japanese Patent Application Laid-Open No. 2006-214955.

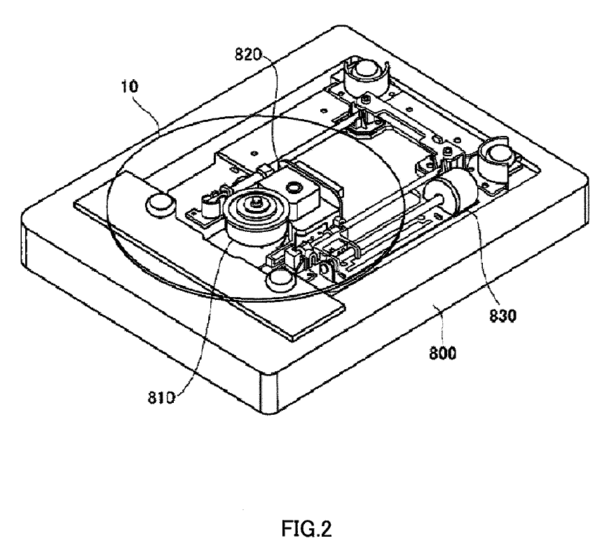

An embodiment of the present invention will be described below with reference to the drawings. FIG. 2 shows an example of the configurations of the sample solution analyzing panel of the present invention and the analyzing apparatus using this. As shown in FIG. 2, sample solution analyzing panel 10 is attached to analyzing apparatus 800. In FIG. 2, analyzing apparatus 800 has: spindle motor 810 that rotates sample solution analyzing panel 10; optical pickup 820 that irradiates the plasma supplied in sample solution analyzing panel 10 with a light beam; feed motor 830 for moving optical pickup 820 in the direction parallel to the plane of rotation of sample solution analyzing panel 10 and vertical to the direction of rotation (herein after “panel radial direction”).

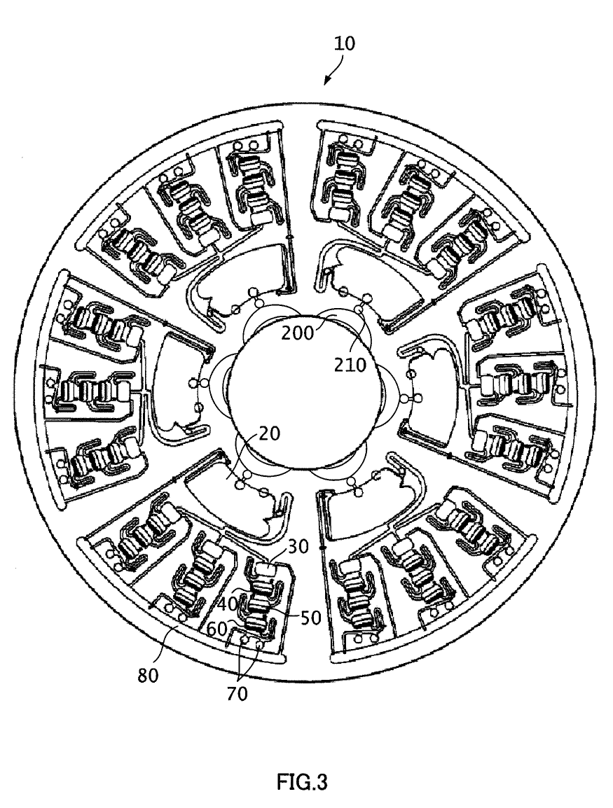

Sample solution analyzing panel 10 can be a sample solution analyzing panel for using blood as a sample solution and measuring the overall cholesterol level in the plasmas. In the sample solution analyzing panel, for example, flow path configurations shown in FIG. 3 including chambers and flow paths are formed. In FIG. 3, six flow path configurations are formed in total. Each flow path configuration includes quantifying chamber 200, capillary valve 210, blood cell separating chamber 20, waste solution chamber 80, three centrifugal separation quantifying chambers 30, three reagent storage chambers 40, three reagent storage chambers 50, three reagent storage chambers 60, and six measurement chambers 70.

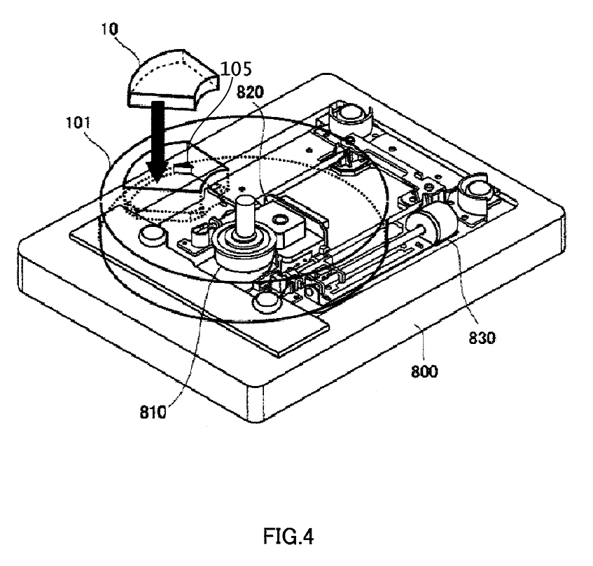

As shown in FIG. 3, sample solution analyzing panel 10 may be a round member where a plurality of flow path configurations are formed. On the other hand, as shown in FIG. 4, sample solution analyzing panel 10 may be a member that can be attached to and removed from stage 101. Analyzing apparatus 800 in FIG. 4 has: stage 101 for fixing and rotating sample solution analyzing panel 10; spindle motor 810; optical pickup 820 that irradiates the plasma supplied in sample solution analyzing panel 10 with a light beam; and feed motor 830 for moving optical pickup 820 in the panel radial direction of sample solution analyzing panel 10.

In stage 101 in FIG. 4, a concave part for fitting in and fixing sample solution analyzing panel 10 is formed. In the concave part, the part corresponding to measurement chamber 70 of fitted sample solution analyzing panel 10 preferably penetrates stage 101. As shown in FIG. 4, sample solution analyzing panel 10 may be supported from below by providing step 105 in part around the penetrating part corresponding to sample solution analyzing panel 10 formed in stage 101.

When the cholesterol level in the plasma is measured using sample solution analyzing panel 10 as a cholesterol level measuring panel, a reaction mechanism including the following chemical reactions 1, 2 and 3 can be used.

E-Chol→Chol (enzyme: ChE) Chemical reaction 1

Chol+NAD→cholestenon+NADH (enzyme: ChDH) Chemical reaction 2

NADH+WST-9→NAD+formazan (enzyme: DI) Chemical reaction 3

Abbreviations in chemical reactions 1 to 3 are as follows.

E-Chol is cholesterol ester. Most of the cholesterol in the plasma is esterified.

Chol is cholesterol.

ChE is an enzyme that catalyzes the reaction of changing E-Chol to Chol. ChE specifically shows cholesterol esterase (EC3.1.1.13).

NAD is nicotin adenine dinucleotide, which is the coenzyme of ChDH.

NADH is a reduction state of NAD.

ChDH is cholesterol dehydrogenase. For example, cholesterol dehydrogenase is available from Amano Enzyme Inc.

WST-9 is water-soluble tetrazolium-9, which is a type of tetrazolium salt available from Dojindo Laboratories (WST-9: 2-(4-nitrophenyl)-5-phenyl-3-[4-(4-sulfophenylazo)-2-sulfophenyl]-2H-tetrazolium.).

DI is an enzyme that catalyzes the oxidation reaction of NADH to NAD and the reduction state conjugated with the reaction. Specifically, DI is diaphorase (EC1.6.99.2).

The absorbance of formazan produced by chemical reaction 3, at a wavelength of 650 mm is measured, and the overall cholesterol level is calculated based on the amount of change in the absorbance.

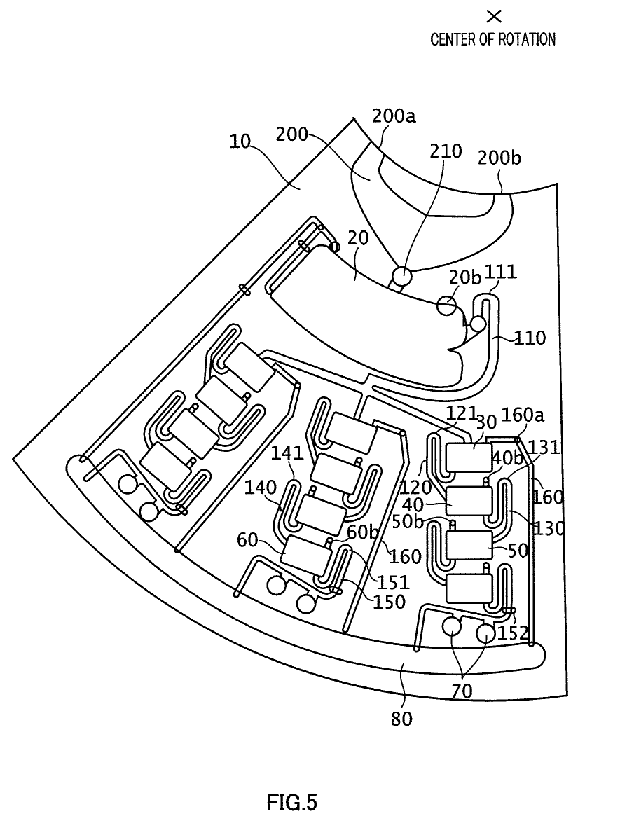

FIG. 5 shows an example of cholesterol level measuring panel 10. Cholesterol level measuring panel 10 has quantifying chamber 200, capillary valve 210 that is connected to the side wall of the outer periphery of quantifying chamber 200 and that has a thicker void than the void in quantifying chamber 200, and blood cell separating chamber 20 that communicates with capillary valve 210. Capillary valve 210 is connected to a side wall in the intermediate part between sample supply port 200a and air vent 200b of quantifying chamber 200. Plasma separating chamber 20 extracts only the plasmas by removing the blood cells from blood by centrifugal separation.

In quantifying chamber 200, sample supply port 200a for making blood flow into quantifying chamber 200 and air vent 200b which opens at the opposite end part of sample supply port 200a, are formed. The blood that flows into through sample supply port 200a intrudes by capillary action and fills quantifying chamber 200, and air in quantifying chamber 200 is exhausted through air vent 200b.

Further, in cholesterol level measuring panel 10, post centrifugal separation quantifying chamber 30 for extracting a certain amount of plasmas from the plasmas extracted by blood cell separating chamber 20; reagent storage chamber 40 where the ChE layer, which is a solid reagent containing ChDH, is accumulated; reagent storage chamber 60 where a WST-9 layer, which is a solid reagent containing WST-9, is accumulated; measurement chamber 70 for measuring the absorbance of formazan at a wavelength of 650 mm; and waste solution chamber 80 for wasting a solution which is no longer required, are formed.

The reagent layers of reagent storage chambers 40, 50 and 60 may be accumulated on a surface orthogonal to the thickness direction (herein after “panel thickness direction”) of cholesterol level measuring panel 10.

Three post centrifugal separation quantifying chambers 30 are arranged for one blood cell separating chamber 20. Each of reagent storage chambers 40, 50 and 60 is arranged for one post centrifugal separation chamber 30. Two measurement chambers 70 are arranged for one reagent storage chamber 60. One waste solution chamber 80 is arranged for one blood cell separating chamber 20.

To make the circulation of liquid in cholesterol level measuring panel 10 smooth, air vent 200b, air vent 20b, and air vents 40b, 50 band 60b are formed in quantifying chamber 200, blood cell separating chamber 20, reagent storage chambers 40, 50 and 60, respectively. The air vents allow air to pass through.

When cholesterol level measuring panel 10 is driven by analyzing apparatus 800 (see FIG. 4), blood supply port 200a and the air vents (200b, 20b, 40b, 50b and 60b) are arranged in the positions such that a sample solution does not leak out from inside cholesterol level measuring panel 10. Particularly, the farthest end part of air vent 200b, from the center of rotation of cholesterol level measuring panel 10 and an opening part of sample supply port 200a that is open in the face perpendicular to the plane of rotation of the panel, are positioned on the same circumference around the center of rotation.

The capacity of quantifying chamber 200 is made smaller than the capacity of blood cell separating chamber 20, so that the blood supplied to quantifying chamber 200 is all sent to blood cell separating chamber 20. Further, the capacity of quantifying chamber 200 is set so that the plasmas separated in blood cell separating chamber 20 are transferred to the subsequent chambers and an amount of plasmas enough for measurement is provided.

The shape of the plane of reagent storage chambers 40, 50 and 60, orthogonal to the panel thickness direction, is made an approximate rectangle of 2.0 mm×5.0 mm, and the side of 5.0 mm is approximately orthogonal to the panel radial direction. Further, the depth of reagent storage chambers 40 and 50 in the panel thickness direction is 300 μm.

The shape of the plane of measurement chamber 70, orthogonal to the panel thickness direction is a round with a diameter of 2 mm, and measurement chamber 70 has a volume of approximately 1 μl. Although an adequate depth of measurement chamber 70 in the panel thickness direction is 200 μm in a case of the present embodiment, generally, the depth of measurement chamber 70 is equivalent to the optical path length upon measurement of transmitted light. Therefore, the depth of measurement chamber 70 needs to be set adequately so that the concentration of matters to be measured (cholesterol) can be measured based on changes in the amount of transmitted light or absorbance. Further, the overall cholesterol level in the plasmas can be measured based on changes in the absorbance with respect to the transmitted light of the wavelength of 650 nm, and therefore the face of measurement chamber 70, orthogonal to the panel thickness direction, is made flat, and measurement chamber 70 is made virtually and optically transparent with respect to light of a wavelength of 650 nm.

From the viewpoint of responsiveness and reduction of the measuring time, the number of chambers where a solid reagent is placed is preferably small. However, for the reason described below, in cholesterol level measuring panel 10, the ChE layer required for the reaction of above-described chemical reaction 1, the ChDH layer required for the reaction of above-described chemical reaction 2 and the WST-9 layer required for the reaction of above-described chemical reaction 3 are preferably stored in reagent storage chamber 40, reagent storage chamber 50 and reagent storage chamber 60, respectively.

Although the optimal pH for ChDH is equal to or higher than pH 8 in the alkaline region and a pH buffer is required, ChDH is not stable in the alkaline region. Therefore, preferably, the ChE layer required for the reaction of above-described chemical reaction 1 is stored in reagent storage chamber 40, the ChDH layer required for the reaction of above-described chemical reaction 2 is stored in reagent storage chamber 50, and the pH buffer is combined not in the ChDH layer but in the ChE layer. ChE that is stable and has good responsiveness in the alkaline region is available from commercially available items.

Further, WST-9 tends to inhibit the catalyst activity of ChDH. Therefore, preferably, the ChDH layer required for the reaction of above-described chemical reaction 2 and the WST-9 layer required for the reaction of above-described chemical reaction 3 are stored in different chambers, namely, reagent storage chamber 50 and reagent storage chamber 60, respectively.

As shown in FIG. 5, cholesterol level measuring panel 10 has flow paths 110 to 160 that connect between the chambers. The depth of flow paths 110 to 160 in the panel thickness direction is 100 μm.

Flow path 110 is connected to blood cell separating chamber 20 and connected to the part closer to the center of cholesterol level measuring panel 10 (herein after “center of rotation of the panel”) in post centrifugal separation quantifying chamber 30. Flow path 120 is connected to a part farther from the center of rotation of the panel in post centrifugal separation quantifying chamber 30 and connected to a part closer to the center of rotation of the panel in reagent storage chamber 40. Flow path 130 is connected to a part farther from the center of rotation of the panel in reagent storage chamber 40 and connected to a part closer to the center of rotation of the panel in reagent storage chamber 50. Flow path 140 is connected to a part farther from the center of rotation of the panel in reagent storage chamber 50 and connected to a part closer to the center of rotation of the panel in reagent storage chamber 60. Flow path 150 is connected to a part farther from the center of rotation of the panel in reagent storage chamber 60 and connected to parts closer to the center of rotation of the panel in measurement chamber 70 and waste solution chamber 80. Flow path 160 is connected to a part closer to the center of rotation of the panel in post centrifugal separation quantifying chamber 30 and connected to a part closer to the center of rotation of the panel in waste solution chamber 80.

Flow path 110 has curved part 111 closer to the center of rotation of the panel than blood cell separating chamber 20. In the same way, flow paths 120, 130, 140 and 150 have curved parts 121, 131, 141 and 151 closer to the center of rotation of the panel than post centrifugal separation quantifying chamber 30, reagent storage chambers 40, 50 and 60, respectively.

Flow path 150 has large diameter part 152 between curved part 151, and measurement chamber 70 and waste solution chamber 80. In large diameter part 152, the diameter of the flow path is made larger in a discontinuous manner with respect to the surrounding area. In flow path 160, air vent 160a that allows air to pass is formed to make the circulation of liquid in cholesterol level measuring panel 10 smooth. When cholesterol level measuring panel 10 is driven by analyzing apparatus 800, air vent 160a is arranged in the position where the sample solution does not leak outside from inside measuring panel 10.

A method of manufacturing measuring panel 10 will be described. Plate material 12 of polycarbonate is prepared, where concave parts corresponding to quantifying chamber 200, blood cell separating chamber 20, post centrifugal separation quantifying chamber 30, reagent storage chambers 40, 50 and 60, measurement chamber 70 and waste solution chamber 80, and holes corresponding to air vents 20b, 40b, 50b, 60b and 160a are molded. Plate material 13 of polyethylene terephthalate is prepared separately, where holes corresponding to quantifying chamber 200, sample solution supply port 200a and air vent 200b which open in quantifying chamber 200, blood cell separating chamber 20, post centrifugal separation quantifying chamber 30, reagent storage chambers 40, 50 and 60, measurement chamber 70, waste solution chamber 80 and flow paths 110 to 160, are molded. An adhesive is applied on both faces of plate material 13. Plate material 13 is stacked on plate material 11.

Next, in the part in the plate stacking plate material 11 and plate material 13 corresponding to reagent storage chamber 40, the ChE layer of reagent storage chamber 40 is formed by dropping and drying the reagent solution. The reagent solution is, for example, 5 μl of a solution containing ChE, a surfactant (for example, n-octyl-β-D-thioglucoside or cholic acid sodium salt) for improving catalytic activity of the ChE, tris hydrochloride, which is a pH buffer for regulating pH upon reaction, and DI.

The ChDH layer of reagent storage chamber 50 is formed by dropping and drying the reagent solution in the part in the plate stacking plate material 11 and plate material 13 corresponding to reagent storage chamber 50. The reagent solution is, for example, 5 μl of a solution containing ChDH and DI.

Further, the WST-9 layer of reagent storage chamber 60 is formed by dropping and drying the reagent solution in the part in the plate stacking plate material 11 and plate material 13 corresponding to reagent storage chamber 60. The reagent solution is, for example, 5 μl of a solution containing WST-9.

Then, by stacking plate material 12 subjected to hydrophilicity treatment and plate material 13, cholesterol level measuring panel 10 is manufactured. Although the hydrophilicity treatment is applied by, for example, applying and drying a surfactant dispersed in a solvent, the hydrophilicity treatment is also possible by physical surface modification such as plasma treatment.

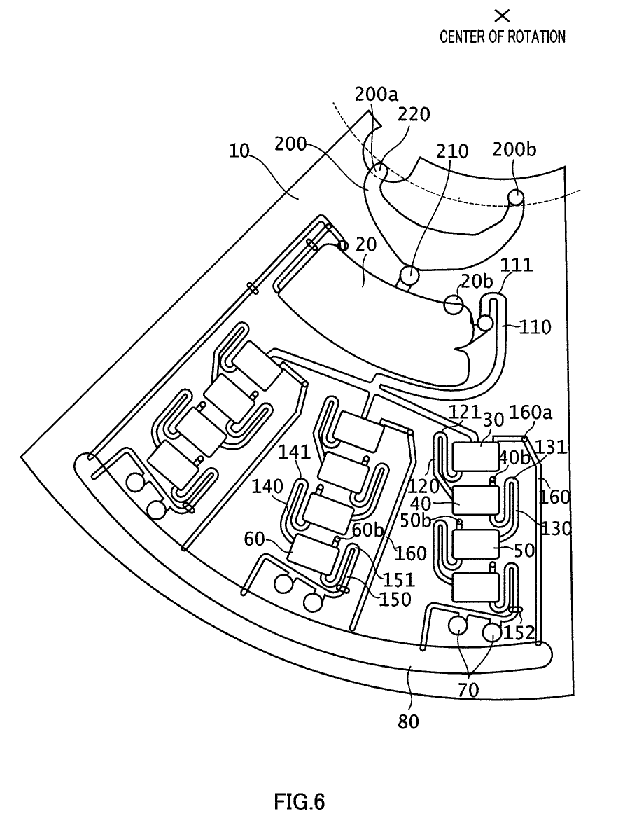

The opening part of sample solution supply port 200a of measuring panel 10 shown in FIG. 3 is formed in the face corresponding to the concave part of stage 101 (see FIG. 4). On the other hand, as shown in FIG. 6, the opening part of sample solution supply port 200a may be formed in the face of concave part 230 of the panel. Concave part 230 has a curvature equivalent to or a little greater than that of a fingertip. By this means, drops of blood bleeding from the fingertip are easily dispensed directly. Further, the positions where drops of blood are to be dispensed is distinguished easily, and drops of blood can be dispensed in sample solution supply port 200a accurately. Therefore, it is possible to prevent blood from adhering to a periphery part near sample solution supply port 200a or prevent the adhered blood from adhering to analyzing apparatus 800.

As shown in FIG. 6, when the opening part of sample solution supply port 200a is formed in the face of concave part 230, the part of air vent 200b farthest from the center of rotation of the panel and the opening part of sample supply port 200a are arranged on the same circumference around the center of rotation. Air vent 200b can be provided by molding and opening a hole in the position meeting plate material 12. Air vent 200b may be provided in the same concave part as concave part 230.

When the opening part of sample solution supply port 200a is provided in the face of concave part 230, either plate material 12 or plate material 11 forming the ceiling part and the floor part, out of the materials constituting sample solution supply port 200a, may protrude in a convex shape (see convex part 220 in FIG. 6). When drops of blood are dispensed from the fingertip, for example, blood that contacts with convex part 220 flows in quantifying chamber 200, and therefore the fingertip does not have to be brought in contact with the periphery of concave part 230 of panel 10. Therefore, it is possible to prevent blood from dispersing between the fingertip and the periphery of concave part 230 and staining the periphery part of concave part 230.

Next, the operation of cholesterol level measuring panel 10 will be described. When blood is brought in contact with blood supply port 200a of cholesterol level measuring panel 10, blood flows in quantifying chamber 200 autonomously by capillary action and reaches the end part of air vent 200b. Quantifying chamber 200 has an opening part in the side wall, which communicates with capillary valve 210, and the height of capillary valve 210 is made greater than the height of quantifying chamber 200 in a discontinuous manner in the part connecting quantifying chamber 200 and capillary valve 210. Therefore, the blood which has flown in quantifying chamber 200 does not flow in capillary valve 210.

Measuring panel 10 where blood fills quantifying chamber 200 is attached to analyzing apparatus 800 (see FIG. 4), and is rotated by spindle motor 810 (see FIG. 4). By this means, blood in quantifying chamber 200 receives a force in a direction to move away from the center of rotation by centrifugal force. Capillary valve 210 is connected to the position farthest from the center of rotation of quantifying chamber 200, and therefore blood held by the capillary valve effect flows in capillary valve 210 by centrifugal force. Further, blood passes through capillary valve 210 and flows in blood cell separating chamber 20.

Blood which has flown in blood cell separating chamber 20 is separated into the blood cells, which are solid components, and the plasmas, which are liquid components, by the action of centrifugal force. Although part of the plasmas separated in blood cell separating chamber 20 flows in flow path 110, while centrifugal force is at work, the solution level of the plasmas in flow path 110 does not come closer to the center of rotation of the panel than the solution level of the plasmas in blood cell separating chamber 20. Therefore, the plasmas do not reach up to curved part 111 which is closer to the center of the panel than blood cell separating chamber 20.

Next, when spindle motor 810 is stopped and the rotation of measuring panel 10 is stopped, the plasmas in blood cell separating chamber 20 and flow path 110 flow in flow path 110 toward post centrifugal separation quantifying chamber 30 by the capillary force of flow path 110. When the plasmas in flow path 110 reach the part connecting flow path 110 and post centrifugal separation quantifying chamber 30, the capillary force of flow path 110 no longer works and the plasmas stay.

Next, when cholesterol level measuring panel 10 is rotated by spindle motor 810, the plasmas in flow path 110 flow in post centrifugal separation quantifying chamber 30 by centrifugal force. While centrifugal force is at work, the plasmas in blood cell separating chamber 20 flow in post centrifugal separation quantifying chamber 30 through flow path 110 by a siphon effect.

Although part of the plasmas which have flown in post centrifugal separation quantifying chamber 30 flows in flow path 120, while centrifugal force is at work, the solution level of the plasmas in flow path 120 cannot come closer to the center of rotation of the panel than the solution level of the plasmas in post centrifugal separation quantifying chamber 30. Therefore, the plasmas do not reach curved part 121 which is closer to the center of the panel than post centrifugal separation quantifying chamber 30.

Further, when the plasmas which have flown in post centrifugal separation quantifying chamber 30 reach the part connecting post centrifugal separation quantifying chamber 30 and flow path 160, extra plasmas further flowing in post centrifugal separation quantifying chamber 30 are discharged to waste pollution chamber 80 through flow path 160.

By stopping spindle motor 810 and the rotation of measuring panel 10, and then rotating measuring panel 10 again by spindle motor 810, the plasmas in post centrifugal separation quantifying chamber 30 flow in reagent storage chamber 40 in the same way as the plasmas in blood cell separating chamber 20, which have flown in post centrifugal separation quantifying chamber 30. The plasmas which have flown in reagent storage chamber 40 contact with the ChE layer stored in reagent storage chamber 40, dissolve the ChE layer and cause the reaction of above-described chemical reaction 1.

Further, by stopping spindle motor 810 and the rotation of measuring panel 10, and then rotating measuring panel 10 again by spindle motor 810, the plasmas in reagent storage chamber 40 flow in reagent storage chamber 50 in the same way as the plasmas in post centrifugal separation quantifying chamber 30, which have flown in reagent storage chamber 40. The plasmas which have flown in reagent storage chamber 50 contact with the ChDH layer stored in reagent storage chamber 50, dissolve the ChDH layer and cause the reaction of above-described chemical reaction 2.

By stopping spindle motor 810 and the rotation of measuring panel 10, and then rotating measuring panel 10 again by spindle motor 810, the plasmas in reagent storage chamber 50 flow in reagent storage chamber 60 in the same way as the plasmas in reagent storage chamber 40, which have flown in reagent storage chamber 50. The plasmas which have flown in reagent storage chamber 60 contact with the WST-9 layer stored in reagent storage chamber 60, dissolve the WST-9 layer and cause the reaction of above-described chemical reaction 3.

When the rotation of stage 101 where cholesterol level measuring panel 10 is placed is stopped by spindle motor 810, the plasmas in reagent storage chamber 60 and flow path 150 flow in flow path 150 toward measurement chamber 70 by the capillary action of flow path 150. When the solution level of the plasmas in flow path 150 reach large diameter part 152, the capillary force of flow path no longer works and the plasmas stay.

Next, when stage 101 where cholesterol level measuring panel 10 is placed is rotated by spindle motor 810, the plasmas in flow path 150 flow in large diameter part 152 by centrifugal force and further flow in measurement chamber 70 and waste solution chamber 80. While the centrifugal force is at work, the plasmas in reagent storage chamber 60 flow in measurement chamber 70 and waste solution chamber 80 through flow path 150 by a siphon effect.

When the plasmas flow in measurement chamber 70, analyzing apparatus 800 moves optical pickup 820 (see FIG. 4) in a direction parallel to the plane of rotation and vertical to the direction of rotation by feed motor 830 (see FIG. 4). Optical pickup 820 irradiates the plasmas in measurement chamber 70 with a light beam while moving, and the analyzing apparatus detects its transmitted light. An analysis is performed by detecting a reaction state of the reagent from the detected transmitted light.

The reagent layers of the reagent storage chambers are dissolved in the plasmas by agitation by the flow of the plasmas flowing in the reagent storage chambers and diffusion in the plasmas flowing in the reagent storage chambers.

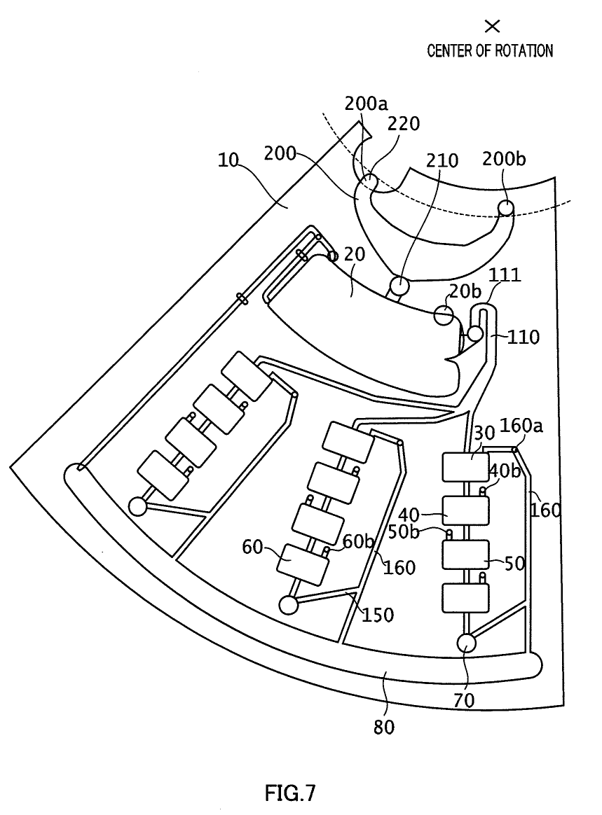

Flow paths 120, 130, 140 and 150 shown in FIG. 6 have curved parts 121, 131, 141 and 151, respectively. As shown in FIG. 7, the flow paths may connect the chambers directly without forming the curved parts. When the chambers are connected through straight flow paths, the plasmas are transferred by utilizing the deterrent force when the plasmas in the chambers flow in the flow paths and centrifugal force by the rotation of the panel.

Although, as in the above-described embodiment, the overall cholesterol level in the plasmas is measured by detecting changes in the absorbance of WST-9, which is a dye, other measuring methods may be adopted. For example, a redox compound which can be electron-transferred to NADH, for example, potassium ferricyanide, can be used. Potassium ferricyanide produces ferricyanide ions in an aqueous solution. Ferricyanide ions are reduced by oxidation of the cholesterol in the plasma and produces ferrocyanide ions. By oxidizing the produced ferrocyanide ions again and measuring an oxidation current value produced upon the oxidation, the overall cholesterol level can be measured. Therefore, electrodes which serve as at least a counter electrode and active electrode are provided in measurement chamber 70, and terminals that can contact with the electrodes in measurement chamber 70 from outside of cholesterol level measuring panel 10 are provided in analyzing apparatus 800. By applying a voltage between the electrodes and oxidizing ferrocyanide ions, an oxidation current value produced upon the oxidation is measured.

The sample solution analyzing panel of the present invention is applicable to measurement of arbitrary target components, in which a change caused by chemical reaction can be optically or electrochemically detected, in addition to measurement of the cholesterol level in the plasmas described in the above embodiment.

### INDUSTRIAL APPLICABILITY

According to the sample solution analyzing panel of the present invention, it is possible to dispense drops of a certain amount of sample solution accurately in a simple manner, secure simple measurement operation and correct measurement values even when the sample solution contains solid components. Therefore, the present invention is particularly applicable to apparatuses for analyzing blood as a sample solution, preferably, measuring devices supporting POCT.

The disclosure of Japanese Patent Application No. 2006-102707, filed on Apr. 4, 2006, including the specification, drawings and abstract, is incorporated herein by reference in its entirety.

1. A panel for analyzing a sample solution to be rotated around a center of rotation, the panel comprising:
a first chamber in a shape of a flow path, into which a sample solution flows by capillary action;
a first flow path which is connected to the first chamber and has cavities in which a dimension of width or height is made large in a discontinuous manner with respect to the first chamber;
a second chamber which is connected to the first flow path;
a supply opening part through which the sample solution is supplied in the first chamber; and
an exhaust opening part through which a gas is exhausted by inflow of the sample solution, wherein:
the first flow path is arranged between the supply opening part and the exhaust opening part;
the supply opening part is open toward the center of rotation set inside the panel or outside the panel;
a distance between the center of rotation and the supply opening part is equal to a distance between the center of rotation and a part in the exhaust opening part farthest from the center of rotation;
a part connecting the first chamber and the first flow path is arranged farther from the center of rotation than the supply opening part and the exhaust opening part; and
at least a part in an inner wall surface of the first chamber is subjected to treating of increasing wettability with respect to the sample solution.

2. The panel according to claim 1, wherein the sample solution comprises a liquid component and a solid component of higher specific gravity than the liquid component.

3. The panel according to claim 2, wherein the second chamber has a configuration such that the solid component is separated from the sample solution to extract only the liquid component in the second chamber.

4. The panel according to claim 2, wherein the second chamber has a configuration such that the solid component is separated from the sample solution to extract the liquid component in the second chamber by a combination of a centrifugal force produced by rotation of the panel and a capillary force that induces transfer of a sample to the second flow path connected to the second chamber.

5. The panel according to claim 1, wherein a side wall farther from the center of rotation in the first chamber has such a shape that the side wall moves away from the center of rotation from the supply opening part to a part connecting with the first flow path without turning to the center of rotation, and has such a shape that the side wall moves away from the center of rotation from the exhaust opening part to the part connecting with the first flow path without turning to the center of rotation.

6. The panel according to claim 1, wherein part of a periphery part of the supply opening part protrudes in a convex shape.
